(19) United States
(12) Patent Application Publication
(10) Pub. No.: US 2004/0150746 A1
(43) Pub. Date: Aug. 5, 2004

(54) Program selecting apparatus

(75) Inventor: Hidemitsu Shimamoto, Tokyo (JP)

Correspondence Address: BIRCH STEWART KOLASCH & BIRCH, PO BOX 747, FALLS CHURCH, VA, 22040-0747, US

(73) Assignee: MITSUBISHI DENKI KABUSHIKI KAISHA, Tokyo (JP)

(21) Appl. No.: 10/747,184

(22) Filed: Dec. 30, 2003

Related U.S. Application Data
(63) Continuation-in-part of application No. 09/694,286, filed on Oct. 24, 2000, now abandoned.

(30) Foreign Application Priority Data
May 15, 2000 (JP) P2000-141650

(51) Int. Cl. G06F 3/00

(52) U.S. Cl. 348/553; 725/38

(57) ABSTRACT

A desirable program is separated from a channel having a plurality of programs multiplexed. A channel number (12) indicative of a channel having a program (last program) received last multiplexed is stored in a first memory (5) and a PID (13) of a PMT for identifying the last program is stored in a second memory (6). During channel selection, a tuner (1) tunes a channel having the last program multiplexed based on the channel number (12). A control circuit (4) retrieves a program corresponding to a PMT having a PID coincident with the PID (13) of the PMT for identifying the last program from the channel, and controls a demultiplexer (3) if there is the coincident program and selectively outputs the program.

### BACKGROUND OF THE INVENTION

1. Field of the Invention

The present invention relates to program selection of a digital broadcasting signal, and more particularly to program selection of a digital broadcasting signal in which a plurality of programs are multiplexed into one channel.

2. Description of the Background Art

A digital broadcasting signal compresses the amount of information of video and voice signals and codes them by using an MPEG 2 (Moving Expert Picture Group 2) mode or the like, and configuration information about programs and various data are added thereto and are multiplexed, and are then modulated digitally and transmitted. In general, several programs are multiplexed if the digital broadcasting signal is a standard signal in an NTSC (National Television System Committee) grade per channel of a terrestrial and one or two programs are multiplexed if the digital broadcasting signal is a high definition signal.

In order to select the programs thus multiplexed, there has been provided a selecting method of allocating a virtual channel number on the transmitting side and inputting the same number on the receiving side.

Referring to a method of selecting a program for television broadcasting which is not multiplexed, there has been proposed a system in which tuning systems are prepared for a plurality of channels respectively and are sequentially switched to compress and store videos and to synthesize them into one image such that a user's channel selection is assisted (Japanese Patent Application Laid-Open No. 11-261920 (1999) and the like). In such a system, it is possible to select a program while visually confirming an actual video.

In the above-mentioned program selecting technique for the multiplexed digital broadcasting signal, the user should know virtual channel numbers in advance, which is not very convenient. Moreover, in the case in which these numbers are not allocated originally or data are defective, a program is selected with difficulty, which is considerably inconvenient. In the program selecting technique for the television broadcasting which is not multiplexed, it is necessary to switch a plurality of tuning systems to synthesize a screen for assisting the program selection. Therefore, there has been a problem in that an operation takes time.

### SUMMARY OF THE INVENTION

A first aspect of the present invention is directed to a program selecting apparatus comprising a tuner for tuning one of a plurality of channels each having a plurality of programs multiplexed, a demultiplexer for separating one of the plurality of programs from the one of the plurality of channels, and a memory for storing channel information for identifying the one of the plurality of channels and program information for identifying the one of the plurality of programs.

A second aspect of the present invention is directed to the program selecting apparatus according to the first aspect of the present invention, wherein the one of the plurality of programs has been viewed last time.

A third aspect of the present invention is directed to the program selecting apparatus according to the first or second aspect of the present invention, wherein the program information is a packet identification data of a program map table for the one of the plurality of programs, and the packet identification data of the program map table for the one of the plurality of programs is retrieved from a plurality of packet identification data described in a program association table in the one of the plurality of channels to separate the one of the plurality of programs.

A fourth aspect of the present invention is directed to a program selecting apparatus comprising a demultiplexer for separating a plurality of programs from a channel having the plurality of programs multiplexed, and a controller for conducting information retrieval about contents of the plurality of programs by using predetermined information, wherein a program selected from the plurality of programs based on the information retrieval is decoded.

A fifth aspect of the present invention is directed to the program selecting apparatus according to the fourth aspect of the present invention, further comprising a decoder for decoding the plurality of programs and acquiring size information to be information about video size as information about contents of the plurality of programs, wherein the controller retrieves one of the plurality of programs having a predetermined video size based on the size information.

A sixth aspect of the present invention is directed to the program selecting apparatus according to the fifth aspect of the present invention, wherein the controller retrieves the one of the plurality of programs having a maximum video size.

A seventh aspect of the present invention is directed to the program selecting apparatus according to the fourth aspect of the present invention, further comprising a memory for storing language information, wherein the demultiplexer acquires voice information to be information about a voice as information about contents of the plurality of programs, and the controller retrieves the voice information by using the language information.

An eighth aspect of the present invention is directed to a program selecting apparatus comprising a demultiplexer for separating a plurality of programs from a channel having the plurality of programs multiplexed, a plurality of decoders each for decoding images corresponding to the plurality of programs, respectively, a memory for synthesizing outputs of the decoders, and a display for displaying contents to be stored in the memory.

A ninth aspect of the present invention is directed to the program selecting apparatus according to the eighth aspect of the present invention, further comprising input means for inputting a selecting signal for selecting one of the plurality of programs, and a controller for discriminating one of the images corresponding to selected one of the plurality of programs from another image.

A tenth aspect of the present invention is directed to the program selecting apparatus according to the ninth aspect of the present invention, wherein the display displays only the one of the images corresponding to the selected one of the plurality of programs.

According to the first aspect of the present invention, a program stored in the storage section can be selected and displayed automatically. Therefore, a user can rapidly select a program suitable for a preference history without knowing the details of the structure of the program.

According to the second aspect of the present invention, it is possible to rapidly select a program viewed last time.

According to the third aspect of the present invention, it is possible to select a desirable program from the tuned channel.

According to the fourth aspect of the present invention, the program multiplexed into one channel is separated and the control section retrieves the contents of the program based on the predetermined information. Therefore, the user can rapidly select a program having a desirable acquired image size without knowing the details of the structure of the program. Thus, it is possible to select a program suitable for the user's preference.

According to the fifth aspect of the present invention, a program having a desirable image size can rapidly be selected and program selection suitable for the user's preference can be carried out.

According to the sixth aspect of the present invention, it is possible to rapidly select a program of a video signal having a maximum acquired image size and a high definition.

According to the seventh aspect of the present invention, the user can rapidly select a program suitable for preference based on the language information without knowing the details of the structure of the program.

According to the eighth aspect of the present invention, a screen synthesizing the videos of the programs multiplexed into one channel is displayed. Therefore, it is possible to rapidly select and view a preferred program while confirming an actual broadcasting signal.

According to the ninth aspect of the present invention, it is possible to easily ascertain which image of a program is to be selected.

According to the tenth aspect of the present invention, only the selected program can be viewed.

Therefore, it is an object of the present invention to easily select a desired program from a large number of programs multiplexed into a channel for television broadcasting.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure according to a first embodiment of the present invention,

FIG. 2 is a diagram illustrating a PAT and a PMT,

FIG. 3 is a flow chart showing an operation according to the first embodiment of the present invention,

FIG. 4 is a block diagram showing a structure according to a second embodiment of the present invention,

FIG. 5 is a flow chart showing an operation according to the second embodiment of the present invention,

FIG. 6 is a block diagram showing a structure according to a third embodiment of the present invention,

FIG. 7 is a flow chart showing an operation according to the third embodiment of the present invention,

FIG. 8 is a block diagram showing a structure according to a fourth embodiment of the present invention, and

FIG. 9 is a flow chart showing an operation according to the fourth embodiment of the present invention.

### DESCRIPTION OF THE PREFERRED EMBODIMENTS

### First Embodiment

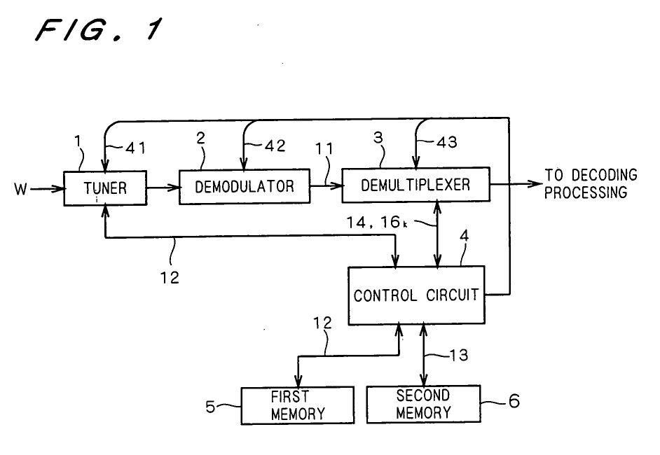

FIG. 1 is a block diagram showing a program selecting apparatus according to a first embodiment of the present invention. A tuner 1 selects and receives a predetermined channel from a digital broadcasting signal in an MPEG mode, and transmits the same channel to a demodulator 2. The demodulator 2 demodulates the channel and outputs a transport stream (TS) signal 11. Then, a demultiplexer 3 separates a digital signal which has been demodulated but has been multiplexed. The tuner 1, the demodulator 2 and the demultiplexer 3 are controlled in response to control signals 41, 42 and 43 generated by a control circuit 4, respectively.

Furthermore, a first memory 5 and a second memory 6 are provided to store information about programs received last time and transmit the contents to the control circuit 4. More specifically, the first memory 5 stores a channel number (hereinafter referred to as a “last channel number”) 12 in which a program received last time (hereinafter referred to as a “last program”) is multiplexed, and the second memory 6 stores packet identification data (PID) 13 of a program map table (PMT) for identifying the last program.

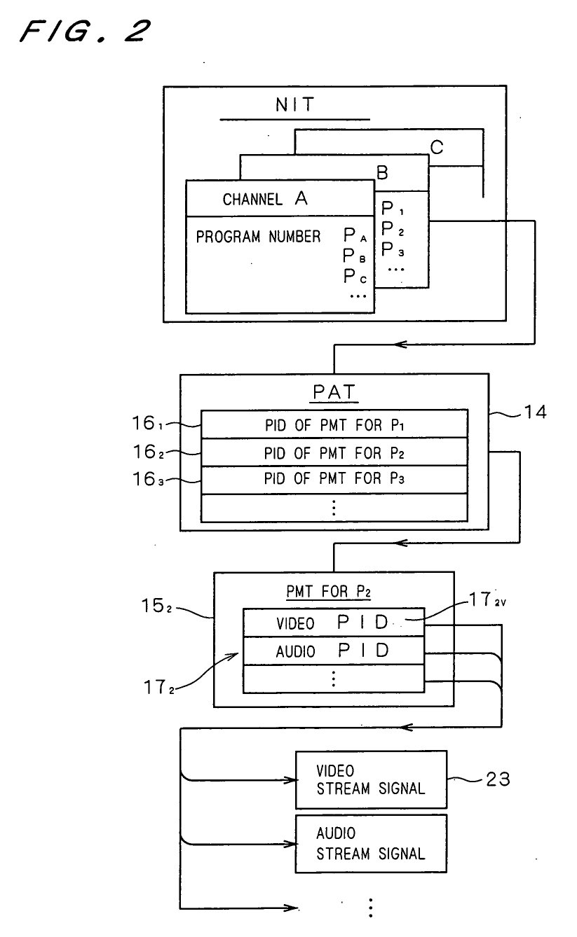

FIG. 2 is a diagram illustrating the last channel number 12 and the PID (hereinafter referred to as a “last PID”) 13 for identifying the last program. In network information (NIT), channels A, B, C, . . . are prepared. For example, programs represented as program numbers P_{A}, P_{B}, P_{C}, . . . are multiplexed in the channel A and programs represented as program numbers P₁, P₂, P₃, . . . are multiplexed in the channel B.

If the last program is delivered in the channel B, “B” is stored as the last channel number 12 in the first memory 5. In a program association table (PAT) 14 on the transmission channel B, moreover, PIDs 16₁, 16₂, 16₃, . . . for the PMT of the programs represented as the program numbers of P₁, P₂, P₃, . . . are set. Accordingly, if the last program is P₂, the PID 16₂ is stored as the last PID 13 in the second memory 6.

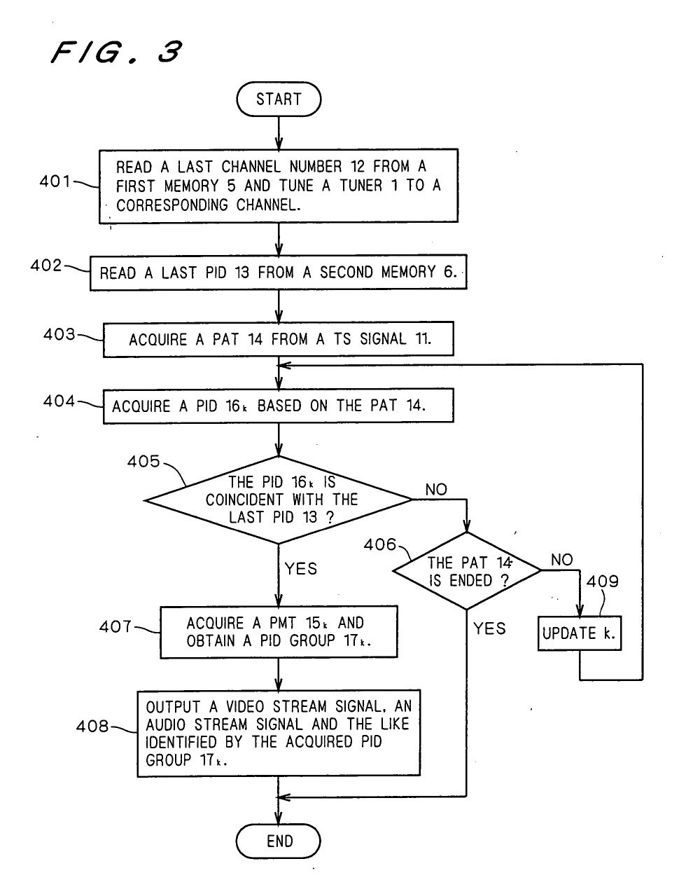

FIG. 3 is a flow chart showing an operation according to the first embodiment of the present invention. A digital broadcasting signal W transmitted from a broadcasting station is acquired by an antenna which is not shown and is then led to the tuner 1. At Step 401, the control circuit 4 accesses the first memory 5 to read the last channel number 12 and transmits the same to the tuner 1. The tuner 1 tunes a channel corresponding to the last channel number 12. In the above-mentioned example, the channel corresponding to the last channel number 12 has been the channel B. Therefore, the tuner 1 tunes the channel B.

At Step 402, next, the control circuit 4 accesses the second memory 6 and reads the last PID 13.

On the other hand, an output of the tuner 1 is transmitted to the demodulator 2, and the demodulator 2 carries out a demodulating operation and outputs the TS signal 11. The TS signal 11 output from the demodulator 2 is transmitted to the demultiplexer 3 and the PAT 14 is acquired from the TS signal 11. Furthermore, the control circuit 4 acquires the PAT 14 (Step 403). The PAT 14 has a value of the PID fixed to “0”, for example. Therefore, the demultiplexer 3 does not particularly require information about the value of the PID of the PAT 14. The Steps 402 and 403 may have processing order exchanged.

As illustrated in FIG. 2, the PIDs 16₁, 16₂, 16₃, . . . for the PMT of various programs are set in the PAT 14. It is assumed that n programs P₁ to Pₙ are multiplexed in the channel B and a PMT 15ₖ is set as a PMT for a program Pₖ and a PID 16ₖ is set as a PID for the PMT 15ₖ (1≦k≦n). At Step 404, the control circuit 4 acquires the PID 16ₖ which is one of the PIDs 16₁ to 16ₙ described in the PAT 14. At Step 405, the control circuit 4 compares the PID 16ₖ acquired at the Step 404 with the last PID 13 read from the second memory 6. If they are coincident with each other, the processing proceeds to Step 407. If they are not coincident with each other, the processing proceeds to Step 406.

At the Step 406, it is decided whether the PID other than that acquired at the Step 404 is left in the PAT 14. If all the PIDs 16₁ to 16ₙ described in the PAT 14 have already been acquired at the Step 404, it is referred that the PAT 14 is “ended” and the control is thus ended. In this case, a newly received digital broadcasting signal W does not include a last program.

If it is decided that the PAT 14 is not ended, the processing proceeds to Step 409 where k is updated and then returns to the Step 404. More specifically, any of the PIDs 16₁ to 16ₙ described in the PAT 14 which has not been acquired at the Step 404 is newly acquired at the Step 404.

If the PID 16ₖ is coincident with the last PID 13, the PID 16ₖ is returned to the demultiplexer 3 through the control circuit 4 and the demultiplexer 3 acquires the PMT 15ₖ based on the PID 16ₖ. In the above-mentioned example, the last program is P₂. Therefore, the PMT 15₂ is acquired based on the PID 16₂. Then, a PID group 17₂ including PIDs of a video (image) and audio (voice) constituting the program P₂ (which will be hereinafter referred to as a “video PID” and an “audio PID”, respectively) described in the PMT 15₂ and the like is acquired (Step 407). At Step 408, the demultiplexer 3 transmits a video stream signal and an audio stream signal which are identified by the PID group 17₂ to each decoder which is not shown, and the decoder decodes them and reproduces a video and a voice.

According to the present embodiment described above, a memory for storing identification information about a program viewed last time is provided and a program coincident with the identification information can be automatically retrieved and be separated from a predetermined channel. Therefore, a user can rapidly select a program suitable for a preference history without knowing the details of the structure of the program.

In the case in which the user newly selects a program and a viewing operation is then ended, the channel number and the PID of the PMT for the last program are stored in the first and second memories 5 and 6, respectively. In other words, the last channel number 12 and the last PID 13 are updated.

Of course, the second memory 6 may store the PID of the PMT for a program viewed before as well as the last PID 13. Also in that case, the user can select a program more easily than in a conventional art. Moreover, the first and second memories 5 and 6 do not need to be separated from each other and the same memory device can also be used.

### Second Embodiment

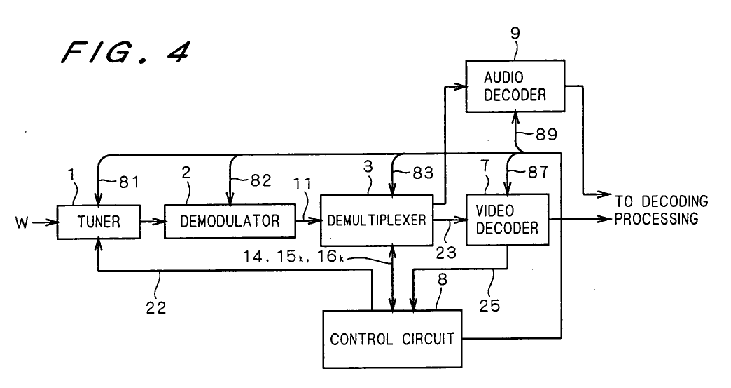

FIG. 4 is a block diagram showing a program selecting apparatus according to a second embodiment of the present invention. A tuner 1, a demodulator 2 and a demultiplexer 3 are the same as those described in the first embodiment, respectively. A video decoder 7 and an audio decoder 9 input and decode a video stream signal and an audio stream signal which are separated by the demultiplexer 3, respectively. Moreover, a control circuit 8 controls the operation of the tuner 1, the demodulator 2 and the demultiplexer 3 in response to control signals 81, 82 and 83 in the same manner as that in the first embodiment, and also controls the operation of the video decoder 7 and the audio decoder 9 in response to control signals 87 and 89.

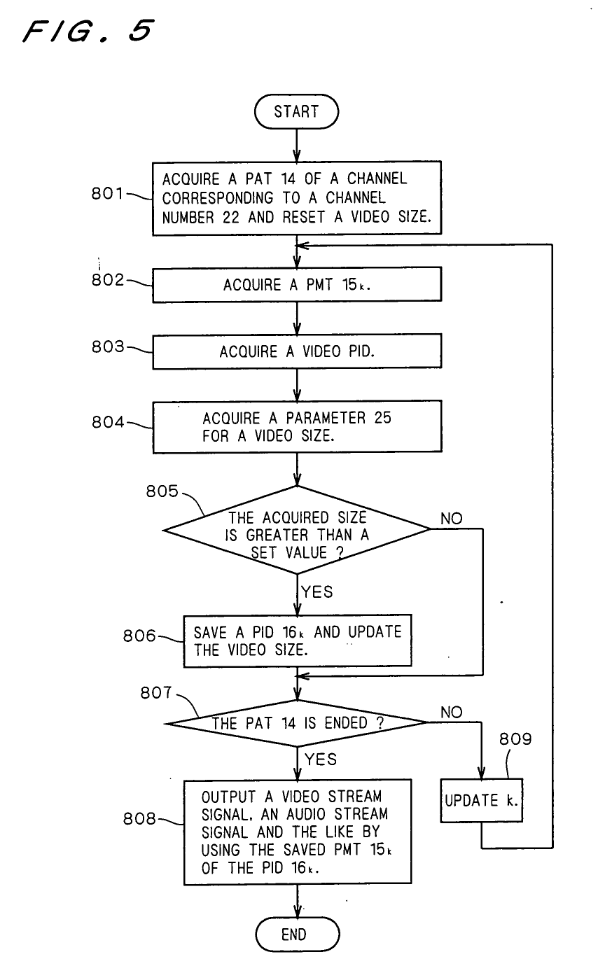

FIG. 5 is a flow chart showing an operation according to the second embodiment of the present invention. A digital broadcasting signal W sent from a broadcasting station is acquired by an antenna which is not shown, and is then led to the tuner 1. A user gives a designation of a desired channel to the control circuit 8. At Step 801, the control circuit 8 transmits a channel number 22 to the tuner 1 based on the designation and tunes the channel. An output of the tuner 1 is transmitted to the demodulator 2, and the demodulator 2 carries out a demodulating operation to output a TS signal 11. The TS signal 11 output from the demodulator 2 is transmitted to the demultiplexer 3 and a PAT 14 for the channel is acquired from the TS signal 11. The operation will be described where the channel B corresponds to the channel number 22 with reference to the example according to the first embodiment (see FIG. 2).

At the Step 801, the control circuit 8 acquires the PAT 14 from the demultiplexer 3, and sets, to zero, a variable holding the numbers of pixels and lines which is a parameter for a video size (hereinafter referred to as “reset a video size”). The variable is maintained in a memory region of the control circuit 8 which is not shown. The video size may be reset before the PAT 14 is acquired.

Next, the demultiplexer 3 acquires a PMT 15ₖ based on a PID 16ₖ described in the PAT 14 at Step 802 and acquires a video PID from the PMT 15ₖ at Step 803. With reference to FIG. 2, for example, a PMT 15₂ is acquired based on a PID 16₂ and a video PID 17₂ᵥ described therein is acquired.

At Step 804, subsequently, the demultiplexer 3 outputs a video stream signal 23 by using the video PID. The video stream signal 23 is transmitted to a video decoder 7. The video decoder 7 acquires, from the video stream signal 23, a parameter for the numbers of pixels and lines of the video signal included in a sequence header, that is, a parameter 25 for the video size and transmits the parameter 25 to the control circuit 8.

At Step 805, next, the parameter 25 is compared with the variable maintained in the memory region of the control circuit 8 which is not shown. If the parameter 25 is greater than the variable, the processing proceeds to Step 806. If not so, the processing proceeds to Step 807.

At the Step 806, the control circuit 8 acquires the PID 16ₖ from the demultiplexer 3 and temporarily holds the same, and the variable maintained in the control circuit 8 is updated by using the parameter 25. In other words, the video size is updated. Then, the processing proceeds to Step 807 where it is decided whether the PAT 14 has the PMT 15ₖ which has not been acquired at the Step 802. If all the PMTs 15₁ to 15ₙ have already been acquired at the Step 802, that is, the PAT 14 is ended, the processing proceeds to Step 808. If not so, k is updated at Step 809 and the processing then returns to the Step 802. More specifically, any of the PMTs 15₁ to 15ₙ described in the PAT 14 which has not been acquired at the Step 802 is newly acquired at the Step 802.

At the Step 808, the PID 16ₖ held at the Step 806 is returned to the demultiplexer 3 and the PMT 15ₖ is acquired so that such as a video PID, an audio PID constituting a program Pₖ are obtained. The video stream signal 23 and the audio stream signal thus obtained are transmitted to the video decoder 7 and the audio decoder 9 and are then decoded so that a video and a voice are reproduced by a display device and an acoustic device which are not shown.

With reference to FIG. 2, the Step 806 is executed for all the PMTs 15₁ to 15ₙ, the PID 16₂ is held in the control circuit 8, the demultiplexer 3 acquires the PMT 15₂ based on the PID 16₂ and a video PID 17₂ᵥ described therein is obtained. The video stream signal 23 identified by the video PID 17₂ᵥ and the audio stream signal are given to the video decoder 7 and the audio decoder 9.

As described above, the Step 806 is repetitively executed. Consequently, the PID 16ₖ held in the control circuit 8 during the execution of the Step 808 identifies the PMT for any of the programs P₁ to Pₙ which has the greatest image size.

More specifically, information about an image size of a video signal is acquired from a separated signal for a program multiplexed into one channel. Therefore, a user can rapidly select a program of the video signal having the greatest image size and high definition thus acquired without knowing the details of the structure of the program. Thus, it is possible to select a program suitable for the user's preference.

By expression in a generic concept, the demultiplexer 3 separates a plurality of programs from a channel having the programs multiplexed, and the control circuit 8 retrieves information about the contents of each program by using predetermined information and the program selected based on the result of the retrieval is decoded by the video decoder 7 and the audio decoder 9.

Of course, in the present embodiment, the video size is set to have such a great value as not to be usually employed at the Step 801 and the decision at the Step 805 is changed to “whether the acquired size is smaller than a set value?”. Consequently, it is possible to obtain a program having the smallest video size. In the present embodiment, thus, it is possible to select a program according to a user's preference for a video size.

### Third Embodiment

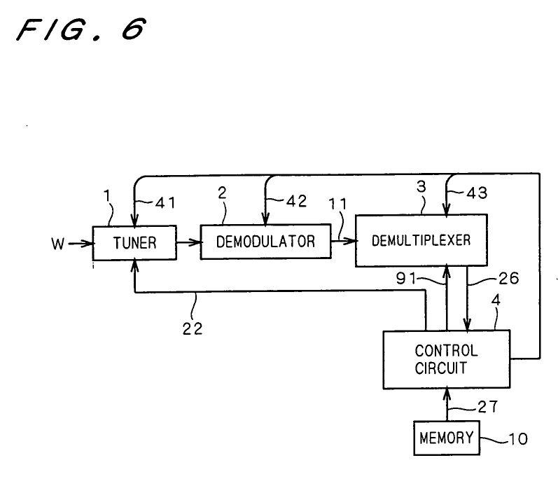

FIG. 6 is a block diagram showing a program selecting apparatus according to a third embodiment of the present invention. A tuner 1, a demodulator 2 and a demultiplexer 3 are the same as those described in the first embodiment, and a control circuit 4 serves to control the operation of the tuner 1, the demodulator 2 and the demultiplexer 3 in response to control signal 41, 42 and 43 in the same manner as that in the first embodiment. In the present embodiment, the tuner 1 has the function of corresponding to an MPEG mode including voice compression of an AC3 mode. Moreover, the program selecting apparatus is also provided with a memory 10 in which language information 27 of a voice desired by a user is previously stored.

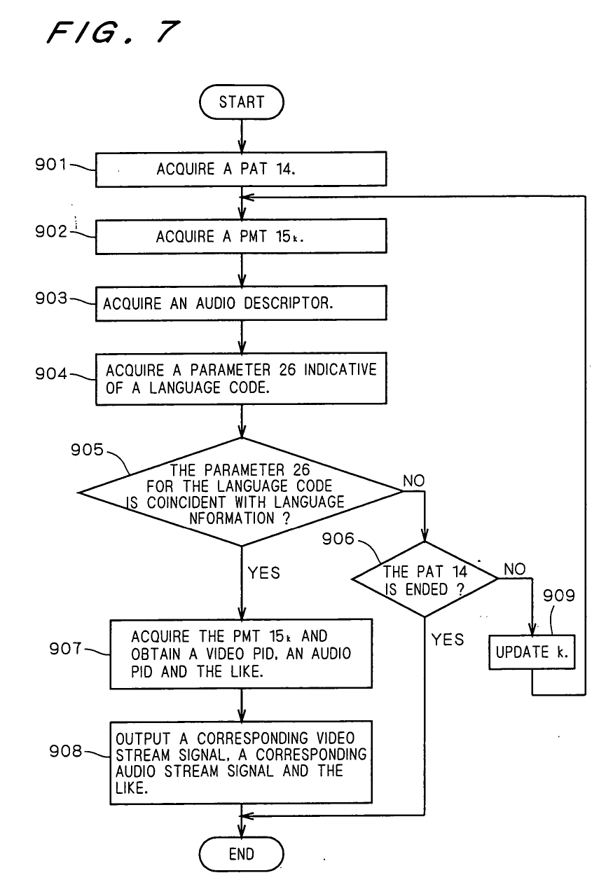

FIG. 7 is a flow chart showing an operation according to the third embodiment of the present invention. At Step 901, a channel specified by the user, for example, a number 22 of a channel B is given to the tuner 1 in the same manner as in the second embodiment, and the control circuit 4 acquires a PAT 14 for the channel. At Step 902, next, a PID 16ₖ described in the PAT 14 is acquired and a PMT 15ₖ is acquired based on the PID 16ₖ in the same manner as in the Step 404.

In the voice compression mode using the AC3 mode, the PMT includes an audio descriptor having a parameter indicative of a language code. Then, the processing proceeds to Step 903 where the demultiplexer 3 acquires the audio descriptor from the PMT 15ₖ. Thereafter, the processing proceeds to Step 904 where a parameter 26 indicative of a language code is acquired from the audio descriptor. This is temporarily held in a memory region of the control circuit 4 which is not shown, for example.

At Step 905, the control circuit 4 decides whether the language information 27 previously stored in the memory 10 is coincident with the contents of the parameter 26 acquired at the Step 904. If they are coincident with each other, the processing proceeds to Step 907. If not so, the processing proceeds to Step 906.

At the Step 906, it is decided whether the PAT 14 has the PMT 15ₖ which has not been acquired at the Step 902. If all the PMTs 15₁ to 15ₙ have already been acquired at the Step 902, that is, the PAT 14 is ended, the control is ended. In this case, a program including the language information 27 of a voice desired by the user has not been multiplexed in the channel specified by the user. If the PAT 14 is not ended, k is updated at Step 909 and the processing then returns to the Step 902. In other words, any of the PMTs 15₁ to 15ₙ described in the PAT 14 which has not been acquired at the Step 902 is newly acquired at the Step 902.

At Step 907, for example, the control circuit 4 transmits, to the demultiplexer 3, a signal 91 indicating whether the parameter 26 sent from the demultiplexer 3 is coincident with the language information 27. Based on the signal 91, the demultiplexer 3 acquires the PMT 15ₖ comprising the audio descriptor including the parameter 26 which is coincident with the language information 27 of a voice desired by the user. A video PID, an audio PID and the like described therein are obtained. At Step 908, the demultiplexer 3 outputs a video stream signal and an audio stream signal which correspond to these PIDs. The signals are decoded by a video decoder and an audio decoder which are not shown, and a video and a voice are reproduced.

As described above, in the present embodiment, language information about the voice desired by the user can be previously held in the memory and a program having a voice coincident with the language of the memory can be retrieved and can be selected and displayed automatically. Therefore, the user can rapidly select a program suitable for the preference without knowing the details of the structure of the program.

By expression in a generic concept, the demultiplexer 3 separates a plurality of programs from a channel having the programs multiplexed, and the control circuit 4 retrieves information about the contents of each program by using predetermined information and the selected program is decoded based on the result of the retrieval.

While the case in which the parameter 26 indicative of the language code 2 is acquired from the audio descriptor in the PMT has been described in the present embodiment, the present invention can also be applied to the case in which the parameter 26 is acquired from other available descriptors.

### Fourth Embodiment

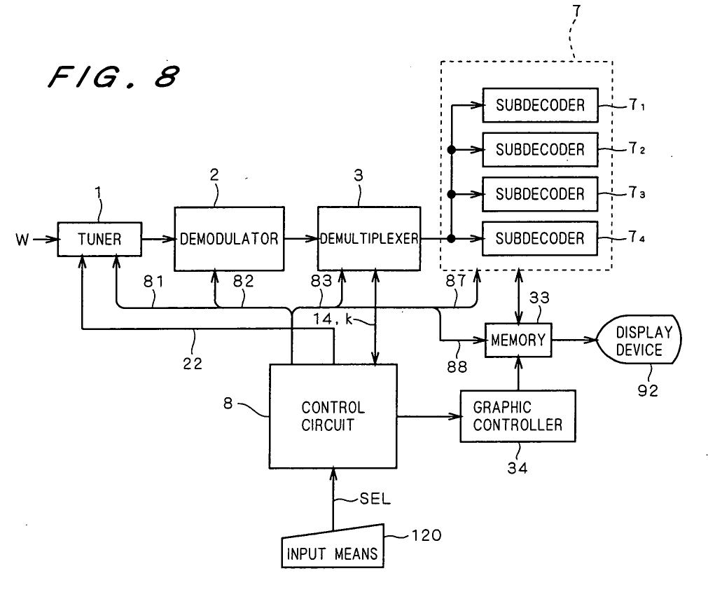

FIG. 8 is a block diagram showing a program selecting apparatus according to a fourth embodiment of the present invention. A tuner 1, a demodulator 2 and a demultiplexer 3 are the same as those in the first embodiment. A video decoder 7 includes four subdecoders 7₁, 7₂, 7₃ and 7₄ for receiving and decoding a video stream signal separated by the demultiplexer 3. A control circuit 8 serves to control the operation of the tuner 1, the demodulator 2, the demultiplexer 3 and the video decoder 7 in response to control signals 81, 82, 83 and 87 in the same manner as that in the second embodiment.

Each of the subdecoders 71 to 74 can decode a video stream of a video signal having a standard resolution (720 pixels, 480 lines, a field frequency of 59.94 Hz). As will be described below, decoded images output from the subdecoders 7₁ to 7₄ are synthesized on a memory 33 by using a graphic controller 34 so that an image corresponding to a high definition video signal (1920 pixels, 1080 lines, a field frequency of 59.94 Hz) is obtained.

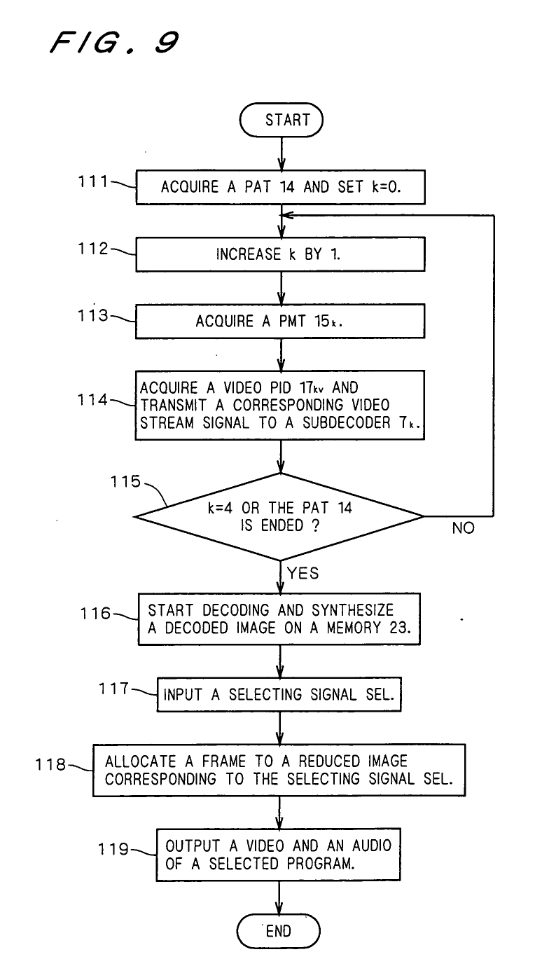

FIG. 9 is a flow chart showing an operation according to the fourth embodiment of the present invention. At Step 111, a channel specified by a user, for example, a number 22 of a channel B is given to the tuner 1 and the control circuit 8 acquires a PAT 14 for the channel in the same manner as in the second embodiment. A variable k maintained in a memory region of the control circuit 8 which is not shown is set to 0 (the variable k is reset). The variable k holds the number of PIDs for the PMT which have been acquired.

Next, the processing proceeds to Step 112 where the variable k is increased by 1. At Step 113, a PID 16ₖ for a kth PMT 15ₖ described in the PAT 14 is acquired and the PMT 15ₖ is acquired by using the PID 16ₖ. At Step 114, a video PID 17ₖᵥ is acquired from the PMT 15ₖ acquired at the Step 113, and a video stream signal corresponding thereto is transmitted to a subdecoder 7ₖ.

At Step 115, next, it is decided whether the variable k reaches the number of the subdecoders, that is, 4. If the k is not 4, the processing returns to the Step 112. If the k is 4, it is decided that the video stream signal is allocated to all the subdecoders 7₁ to 7₄ and the processing then proceeds to Step 116. At Step 115, it is decided whether there is another PMT on the PAT 14, that is, another program on the channel. If k<4 and there is no other PMT, that is, the PAT 14 is ended, the processing proceeds to Step 116. This may be occurred with n<4.

By the above-mentioned steps, the video stream signal is sent to the subdecoders 7₁ to 7_{L} immediately before the processing proceeds to the Step 116, where L is a smaller one of the number of programs multiplexed into the received channel and the value of 4. At the Step 116, each of the subdecoders 7₁ to 7_{L} starts a decoding operation and synthesizes decoded images on the memory 33.

The memory 33 has a capacity capable of storing one frame of a high definition video signal. Information about the decoded video obtained from the subdecoder 7₁ is stored in a storage region of the memory 33 corresponding to an approximately quarter region on the upper left side of one screen of the high definition video signal. Information about the decoded video obtained from the subdecoder 7₂ is stored in a storage region of the memory 33 corresponding to an approximately quarter region on the upper right side of one screen of the high definition video signal. Information about the decoded video obtained from the subdecoder 7₃ is stored in a storage region of the memory 33 corresponding to an approximately quarter region on the lower left side of one screen of the high definition video signal. Information about the decoded video obtained from the subdecoder 7₄ is stored in a storage region of the memory 33 corresponding to an approximately quarter region on the lower right side of one screen of the high definition video signal. Consequently, information about a video for one frame in which four reduced images are synthesized is stored in the memory 33. The contents stored in the memory 33 are subjected to a display processing through a display device 92 and are displayed as a synthetic screen.

At Step 117, next, the control circuit 8 inputs a selecting signal SEL indicating which reduced image in the synthetic screen should be selected by the user referring to the synthetic screen. At Step 118, the control circuit 8 controls a graphic controller 34 based on the selecting signal SEL and stores, in the memory 33, information to be a frame for the reduced image specified by the selecting signal SEL. It is desirable that the Steps 117 and 118 should be repetitively executed plural times, which is not shown in detail in FIG. 9. Consequently, the user can select a program to be viewed through input means 120 while visually confirming the selection of a program easily and can transmit the selecting signal SEL from the input means 120 to a control circuit 11.

At Step 119, only a video signal output from the subdecoder corresponding to the program selected by the user is selectively sent from the memory 33 to the display device 92 in response to a control signal 88 transmitted from the control circuit 8. Consequently, only an image of the selected program is displayed on the display device 92.

As described above, according to the present embodiment, videos of a program multiplexed into one channel are simultaneously synthesized and displayed on the same screen. Therefore, it is possible to rapidly select and view a preferred program while confirming an actual broadcasting signal.

While the number of the subdecoders included in the video decoder 7 has been 4 in the above description, it is not restricted thereto. Although a frame is allocated as a method of discriminating any of the synthesized screens corresponding to a specific program, it is sufficient that a discrimination from other screens is carried out. For example, an auditory discrimination may be carried out in addition to a visual discrimination, such as a function of generating various sounds for specified screens. The function may be integrated in the display device 92 or separately carried out.

While the invention has been described in detail, the foregoing description is in all aspects illustrative and not restrictive. It is understood that numerous other modifications and variations can be devised without departing from the scope of the invention.

What is claimed is:

1. A program selecting apparatus comprising:
a tuner for tuning one of a plurality of channels each having a plurality of programs multiplexed;
a demultiplexer for separating one of said plurality of programs from said one of said plurality of channels; and
a memory for storing channel information for identifying said one of said plurality of channels and program information for identifying said one of said plurality of programs.

2. The program selecting apparatus according to claim 1, further comprising a demodulator for demodulating an output of said tuner and giving a demodulated output to said demultiplexer.

3. The program selecting apparatus according to claim 1, wherein said one of said plurality of programs has been viewed last time.

4. The program selecting apparatus according to claim 1, wherein said program information is a packet identification data of a program map table for said one of said plurality of programs, and
said packet identification data of said program map table for said one of said plurality of programs is retrieved from a plurality of packet identification data described in a program association table in said one of said plurality of channels to separate said one of said plurality of programs.

5. The program selecting apparatus according to claim 3, wherein said program information is a packet identification data of a program map table for said one of said plurality of programs, and
said packet identification data of said program map table for said one of said plurality of programs is retrieved from a plurality of packet identification data described in a program association table in said one of said plurality of channels to separate said one of said plurality of programs.

6. A program selecting apparatus comprising:
a demultiplexer for separating a plurality of programs from a channel having said plurality of programs multiplexed; and
a controller for conducting information retrieval about contents of said plurality of programs by using predetermined information,
wherein a program selected from said plurality of programs based on said information retrieval is decoded.

7. The program selecting apparatus according to claim 6, further comprising a demodulator for demodulating said channel and giving a demodulated channel to said demultiplexer.

8. The program selecting apparatus according to claim 7, further comprising a tuner for selecting said channel from a plurality of channels and giving said channel to said demodulator.

9. The program selecting apparatus according to claim 6, further comprising a decoder for decoding said plurality of programs and acquiring size information to be information about video size as information about contents of said plurality of programs,
wherein said controller retrieves one of said plurality of programs having a predetermined video size based on said size information.

10. The program selecting apparatus according to claim 9, wherein said controller retrieves said one of said plurality of programs having a maximum video size.

11. The program selecting apparatus according to claim 10, further comprising a demodulator for demodulating said channel and giving a demodulated channel to said demultiplexer.

12. The program selecting apparatus according to claim 11, further comprising a tuner for selecting said channel from a plurality of channels and giving said channel to said demodulator.

13. The program selecting apparatus according to claim 6, further comprising a memory for storing language information,
wherein said demultiplexer acquires voice information to be information about a voice as information about contents of said plurality of programs, and
said controller retrieves said voice information by using said language information.

14. The program selecting apparatus according to claim 13, further comprising a demodulator for demodulating said channel and giving a demodulated channel to said separating section.

15. The program selecting apparatus according to claim 14, further comprising a tuner for selecting said channel from a plurality of channels and giving said channel to said demodulator.

16. A program selecting apparatus comprising:
a demultiplexer for separating a plurality of programs from a channel having said plurality of programs multiplexed;
a plurality of decoders each for decoding images corresponding to said plurality of programs, respectively;
a memory for synthesizing outputs of said decoders; and
a display for displaying contents to be stored in said memory.

17. The program selecting apparatus according to claim 16, further comprising input means for inputting a selecting signal for selecting one of said plurality of programs; and
a controller for discriminating one of said images corresponding to selected one of said plurality of programs from another image.

18. The program selecting apparatus according to claim 17, wherein said display displays only said one of said images corresponding to said selected one of said plurality of programs.
